(19) United States
(12) Patent Application Publication
(10) Pub. No.: US 2025/0370246 A1
(43) Pub. Date: Dec. 4, 2025

(54) EYEPIECE OPTICAL SYSTEM AND HEAD MOUNTED DISPLAY

(71) Applicant: Panasonic Intellectual Property Management Co., Ltd., Osaka (JP)

(72) Inventor: Takao YAMANAKA, Osaka (JP)

(21) Appl. No.: 19/304,818

(22) Filed: Aug. 20, 2025

Related U.S. Application Data
(63) Continuation of application No. PCT/JP2024/004551, filed on Feb. 9, 2024.

(30) Foreign Application Priority Data
Feb. 28, 2023 (JP) 2023-029850

(51) Int. Cl. G02B 25/00; G02B 5/30; G02B 15/14; G02B 27/01

(52) U.S. Cl. CPC G02B 25/001; G02B 5/30; G02B 15/142; G02B 27/0172; G02B 27/0176; G02B 2027/0154

(57) ABSTRACT

An eyepiece optical system, for guiding light between a pupil and a display surface, includes: first and second lens groups arranged in order from a pupil side to a display side. The first lens group includes first and second lens elements arranged in order from the pupil side to the display side, and has a first partial reflection surface disposed on the pupil side of the first lens element and a second partial reflection surface disposed between the first lens element and the second lens element. The second lens group includes a third lens element having an aspherical surface convex toward the pupil side. A focal length of the first lens group is equal to or less than five times a difference between a maximum height of a chief ray on a pupil side surface of the first lens element and a maximum image height on the display surface.

### TECHNICAL FIELD

The present disclosure relates to an eyepiece optical system and a head mounted display including the eyepiece optical system.

### BACKGROUND ART

JP 2022-185302 A discloses an observation optical system for observing an image displayed on an image display surface. The observation optical system of JP 2022-185302 A is used as a head mounted display that enlarges and displays an original image displayed on an image display element such as a liquid crystal display. JP 2021-81530 A discloses an observation optical system that enables observation, from a pupil surface, of an optical image of an original picture displayed on a display surface. The observation optical system of JP 2021-81530 A includes a diopter adjustment lens group and a succeeding lens group that are arranged in order from a pupil surface side to a display surface side. The succeeding lens group includes at least one positive lens and thereby shares a part of a refractive power of the entire observation optical system.

### SUMMARY

The present disclosure provides an eyepiece optical system and a head mounted display capable of facilitating ensuring a visual field of a user.

An eyepiece optical system in the present disclosure guides light between a pupil of a user and a display surface. The eyepiece optical system includes: a first lens group and a second lens group that are arranged in order from a pupil side of the user to a display side that is toward the display surface. The first lens group includes a first lens element and a second lens element that are arranged in order from the pupil side to the display side, and has a first partial reflection surface and a second partial reflection surface, the first partial reflection surface being disposed on the pupil side of the first lens element, and the second partial reflection surface being disposed between the first lens element and the second lens element. The second lens group includes a third lens element having an aspherical surface convex toward the pupil side. A focal length of the first lens group is equal to or less than five times a difference between a maximum height of a chief ray on a pupil side surface and a maximum image height on the display surface, the pupil side surface being a surface on the pupil side of the first lens element in the first lens group.

A head mounted display according to the present disclosure includes a display element having the display surface that displays an image, and the above-described eyepiece optical system.

The eyepiece optical system and the head mounted display of the present disclosure can facilitate ensuring a visual field of a user.

### BRIEF DESCRIPTION OF DRAWINGS

FIG. 1 is a diagram illustrating a configuration of a head mounted display according to a first embodiment of the present disclosure;

FIG. 2 is a diagram illustrating a diopter adjustment mechanism in a display device;

FIG. 3 is a lens arrangement diagram showing a configuration of a visual optical system according to a first example;

FIG. 4 is a diagram for illustrating an operation by a visual optical system of the first embodiment;

FIG. 5 is a diagram for illustrating parameters in the visual optical system;

FIG. 6 is a graph illustrating a first comparison result regarding an effect of the visual optical system;

FIG. 7 is a graph illustrating a second comparison result regarding an effect of the visual optical system;

FIG. 8 is a chart showing surface data of a visual optical system in a first numerical example;

FIG. 9 is a chart showing aspherical data of the visual optical system in the first numerical example;

FIG. 10 is a chart showing various data of the visual optical system in the first numerical example;

FIG. 11 is an aberration diagram showing various aberrations of the visual optical system in the first numerical example;

FIG. 12 is a lens arrangement diagram showing a configuration of a visual optical system according to a second example;

FIG. 13 is a chart showing surface data of the visual optical system in a second numerical example;

FIG. 14 is a chart showing aspherical data of the visual optical system in the second numerical example;

FIG. 15 is a chart showing various data of the visual optical system in the second numerical example;

FIG. 16 is an aberration diagram showing various aberrations of the visual optical system in the second numerical example;

FIG. 17 is a lens arrangement diagram showing a configuration of a visual optical system according to a third example;

FIG. 18 is a chart showing surface data of the visual optical system in a third numerical example;

FIG. 19 is a chart showing aspherical data of the visual optical system in the third numerical example;

FIG. 20 is a chart showing various data of the visual optical system in the third numerical example;

FIG. 21 is an aberration diagram showing various aberrations of the visual optical system in the third numerical example;

FIG. 22 is a lens arrangement diagram showing a configuration of a visual optical system according to a fourth example;

FIG. 23 is a chart showing surface data of the visual optical system in a fourth numerical example;

FIG. 24 is a chart showing aspherical data of the visual optical system in the fourth numerical example;

FIG. 25 is a chart showing various data of the visual optical system in the fourth numerical example;

FIG. 26 is an aberration diagram showing various aberrations of the visual optical system in the fourth numerical example;

FIG. 27 is a lens arrangement diagram showing a configuration of a visual optical system according to a fifth example;

FIG. 28 is a chart showing surface data of the visual optical system in a fifth numerical example;

FIG. 29 is a chart showing aspherical data of the visual optical system in the fifth numerical example;

FIG. 30 is a chart showing various data of the visual optical system in the fifth numerical example;

FIG. 31 is an aberration diagram showing various aberrations of the visual optical system in the fifth numerical example;

FIG. 32 is a lens arrangement diagram showing a configuration of a visual optical system according to a sixth example;

FIG. 33 is a chart showing surface data of the visual optical system in a sixth numerical example;

FIG. 34 is a chart showing aspherical data of the visual optical system in the sixth numerical example;

FIG. 35 is a chart showing various data of the visual optical system in the sixth numerical example;

FIG. 36 is an aberration diagram showing various aberrations of the visual optical system in the sixth numerical example; and

FIG. 37 is a chart showing satisfiability of various conditions in the visual optical system according to the first embodiment.

### DETAILED DESCRIPTION

In the following, embodiments will be described in detail with reference to the drawings as appropriate. However, unnecessarily detailed description may be omitted. For example, detailed description of already well-known matters or repeated description of substantially the same configuration may be omitted. This is to prevent the following description from being unnecessarily redundant and to allow a person skilled in the art to easily understand the present disclosure.

Note that the applicant provides the accompanying drawings and the following description in order for those skilled in the art to fully understand the present disclosure, and the drawings and the description are not intended to limit the subject matters of the claims.

### FIRST EMBODIMENT

Hereinafter, a visual optical system as an example of an eyepiece optical system according to the present disclosure and a first embodiment of a head mounted display using the visual optical system will be described.

### 1. Head Mounted Display

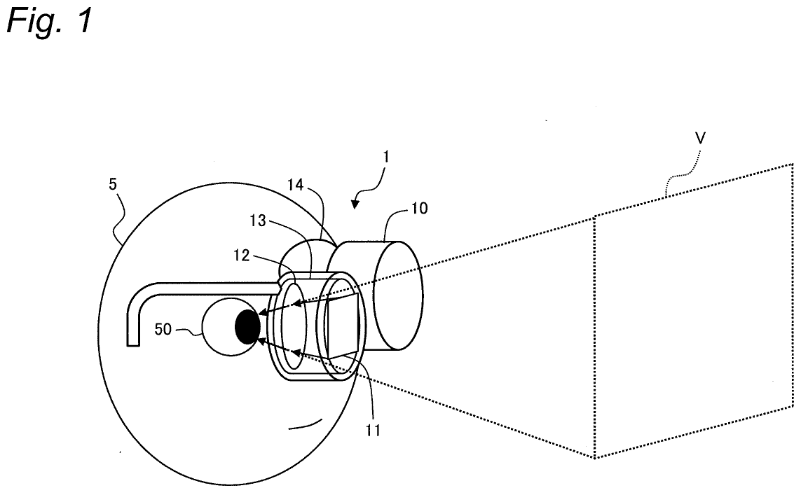

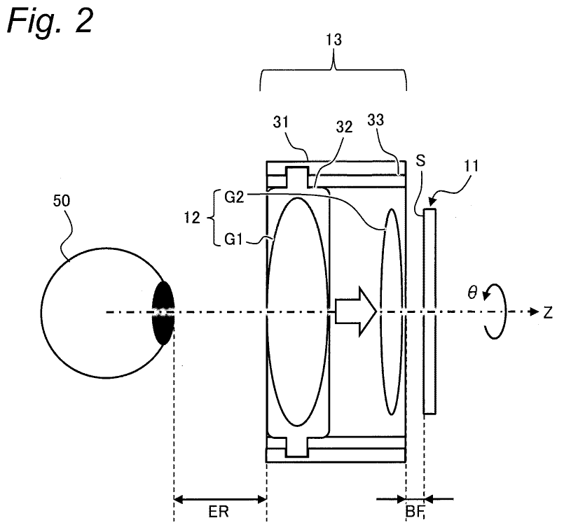

A head mounted display (HMD) according to the first embodiment will be described with reference to FIGS. 1 and 2.

FIG. 1 is a diagram illustrating a configuration of an HMD 1 according to the first embodiment of the present disclosure. The HMD 1 in the present embodiment is a display device that is worn on a head portion of a user 5 to allow the user 5 to view a virtual image V. For example, the HMD 1 is configured as a spectacle type in which two projection units 10 are provided as portions corresponding to both eyes of the user 5.

For example, as illustrated in FIG. 1, the HMD 1 includes a display element 11, a visual optical system 12, and a diopter adjustment mechanism 13, for each projection unit 10. Each projection unit 10 of the HMD 1 projects a display light beam that is light for causing the user 5 to view the virtual image V, from the display element 11 to an eye 50 of the user 5 via the visual optical system 12. Such an HMD 1 is useful to have a wide viewing angle corresponding to an area for causing the user 5 to view the virtual image V, and to be small and light.

For example, the HMD 1 further includes a fixing member 14 that fixes positions of the projection units 10 with respect to the eyes 50 of the user 5 wearing the HMD 1. Examples of such a fixing member 14 include a forehead rest, a nose rest, a frame member, and a fixing band.

The visual optical system 12 in the present embodiment includes a polarizing reflection optical system that folds back an optical path using reflection based on polarization of light. As a result, the visual optical system 12 can be a thin type with a short optical overall length, and the HMD 1 can be easily reduced in size. The visual optical system 12 of the present embodiment has a thin configuration and a configuration that can facilitate ensuring a wide viewing angle in the HMD 1. Details of the visual optical system 12 will be described later.

The diopter adjustment mechanism 13 is an example of a movable mechanism for adjusting the diopter in accordance with the visual acuity of each eye 50 in the HMD 1. For example, with the diopter adjustment mechanism 13, the user 5 can adjust the virtual image V so as to be easily recognized visually in the HMD 1, in accordance with the user's own visual acuity. FIG. 2 illustrates the diopter adjustment mechanism 13.

Hereinafter, as illustrated in FIG. 2, a direction along an optical axis of the visual optical system 12 is defined as a Z direction, a direction rotating around the optical axis is defined as a θ direction, a pupil side, where a pupil of the eye 50 is assumed to be positioned, with respect to the visual optical system 12 is defined as a −Z side, and a display side, where the display element 11 is positioned, with respect to the visual optical system 12 is defined as a +Z side.

The display element 11 includes a display surface S that displays various images. For example, the display surface S includes a plurality of pixels, and emits a display light beam representing an image for causing the user to view the virtual image V. For example, the display element 11 includes a micro organic light emitting diode (OLED) display. Such a display element 11 can facilitate an image quality of the virtual image V viewed by the user 5 to be high-definition. The present embodiment provides the visual optical system 12 capable of facilitating obtaining a wide viewing angle even when the display surface S of the display element 11 is small.

The display element 11 is not limited to the above configuration, and may be e.g. a liquid crystal display device, a reflective liquid crystal device (LCOS), a digital mirror device (DMD), a micro LED display, or various micro displays.

As shown in FIG. 2, the visual optical system 12 has an eye relief ER on the −Z side and a back focus BF on the +Z side along the optical axis, the eye relief ER being a distance from the visual optical system 12 to the eye 50, and the back focus BF being a distance from the visual optical system 12 to the display surface S of the display element 11. The visual optical system 12 includes: a first lens group G1 disposed on the −Z side; and a second lens group G2 disposed on the +Z side.

In the present embodiment, the diopter adjustment mechanism 13 implements adjustment of diopter with a simple configuration in which a first lens group G1 in the visual optical system 12 is moved in the Z direction. For example, in the visual optical system 12, as the first lens group G1 is moved further to the +Z side with the second lens group G2 being fixed, the diopter adjustment mechanism 13 adjusts diopter to correct stronger visual acuity of nearsightedness.

The diopter adjustment mechanism 13 may be configured not to rotate in the θ direction when the first lens group G1 of the visual optical system 12 moves in the Z direction, and is configured with a cam mechanism, for example. For example, as illustrated in FIG. 2, the diopter adjustment mechanism 13 includes a cam cylinder 31, a lens holding portion 32, and a rotation regulating portion 33.

For example, the cam cylinder 31 is a cylindrical member having a helical cam groove, and is configured to be rotatable in the θ direction. The diopter adjustment mechanism 13 may include a member that can be operated by the user 5, and may include a dial or a ring that rotates the cam cylinder 31, for example.

The lens holding portion 32 is a member that holds in its inside the first lens group G1 of the visual optical system 12. In the lens holding portion 32, relative positions between various lenses in the first lens group G1 of the visual optical system 12 are fixed. The lens holding portion 32 is provided with a pin or the like that engages with the cam groove of the cam cylinder 31.

The rotation regulating portion 33 fixes an angular position of the lens holding portion 32 in the θ direction while allowing movement of the lens holding portion 32 in the Z direction. The rotation regulating portion 33 is configured as follows. For example, between the cam cylinder 31 and the lens holding portion 32 there is provided a cylindrical member provided with a hole which extends in the Z direction and through which the pin of the lens holding portion 32 passes.

With the diopter adjustment mechanism 13 as described above, the lens holding portion 32 moves in the Z direction in accordance with the rotation of the cam cylinder 31, and at this time, the rotation of the lens holding portion 32 is restricted. For example, it is possible to suppress a decrease in image quality due to a shift in the angular position of the first lens group G1 of the visual optical system 12.

In the case where the suppression of the above-described decrease in image quality is unnecessary, the diopter adjustment mechanism 13 does not need to restrict the rotation of the first lens group G1 of the visual optical system 12, and may be configured by using a screw fastening method, for example. The visual optical system 12 and the diopter adjustment mechanism 13 may be integrally provided as a module. The eyepiece optical system of the present embodiment may include a diopter adjustment mechanism 13 in addition to the visual optical system 12.

### 2. Visual Optical System

Details of the visual optical system 12 in the present embodiment will be described below.

### 2-1. Configuration

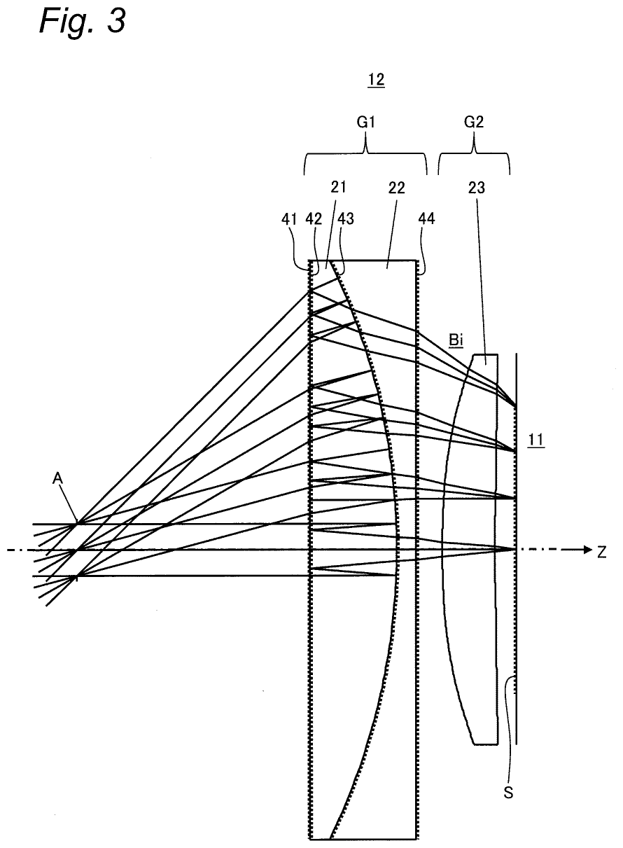

The configuration of the visual optical system 12 in the present embodiment will be described with reference to FIG. 3. In the following description, an example of the visual optical system 12 will be used.

FIG. 3 is a lens arrangement diagram showing a configuration of the visual optical system 12 according to a first example of the present embodiment. FIG. 3 shows a virtual aperture A corresponding to the pupil of the user 5 of the HMD 1 on the −Z side of the visual optical system 12 (hereinafter, the virtual aperture A is also referred to as “pupil A”). FIG. 3 illustrates a light ray in which the display light beam Bi from each part of the display surface S of the display element 11 reaches the pupil A via the visual optical system 12.

The visual optical system 12 in the present embodiment includes a first lens element 21, a second lens element 22, and a third lens element 23 that are arranged in order from the pupil side (−Z side) to the display side (+Z side) along the Z direction of the optical axis. For example, the first lens element 21 and the second lens element 22 constitute the first lens group G1 that is movable in the Z direction while a relative position between the first lens element 21 and the second lens element 22 is fixed. The third lens element 23 constitutes the second lens group G2 whose distance from the display surface S is fixed.

For example, the visual optical system 12 includes the two lens groups G1 and G2 described above, and the distance between the two lens groups G1 and G2 can be changed by using the diopter adjustment mechanism 13 (FIG. 2) described above. FIG. 3 illustrates an arrangement of the visual optical system 12 in a zero diopter state, in which diopter is not adjusted. The position of the first lens group G1 of the visual optical system 12 in the zero diopter state is on the most −Z side within a movable range of the diopter adjustment mechanism 13, for example.

In the visual optical system 12 of the present embodiment, the first lens group G1 has a power (i.e., refractive power) that can ensure a wide viewing angle. Furthermore, the second lens group G2 can correct aberration such as field curvature.

In the first lens group G1 of the visual optical system 12, the first lens element 21 and the second lens element 22 are cemented to each other. The first and second lens elements 21 and 22 are each made of a lens material such as glass or resin, for example. For example, the first and second lens elements 21 and 22 made of a glass material can easily reduce chromatic aberration and the like, so that the image quality of the virtual image V is easily improved.

The first lens element 21 is a reflective polarizing lens including a polarizing reflective surface 41. A surface, of the first lens element 21, on the −Z side is positioned on the most pupil side in visual optical system 12, and faces the eye 50 of the user 5, for example (see FIG. 2).

In the present embodiment, the polarizing reflective surface 41 is provided on the surface, of the first lens element 21, on the −Z side. For example, the polarizing reflective surface 41 is formed as a polarizing reflector by bonding a reflective polarizing film. With respect to linearly polarized light, the polarizing reflective surface 41 reflects light of one polarization component (e.g., p-polarized light) of polarization components orthogonal to each other, and transmits light of the other polarization component (e.g., s-polarized light), for example. The polarizing reflective surface 41 on the −Z side of the first lens element 21 is an example of a first partial reflection surface in the present embodiment.

The first lens element 21 of the first lens group G1 is provided with a ¼ wave plate 42 on the +Z side of the polarizing reflective surface 41. The ¼ wave plate 42 is an example of a retardation element that causes, in incident light, a phase delay of ¼ wavelength in a predetermined polarization direction. For example, the ¼ wave plate 42 is configured by bonding, on the −Z-side surface of the first lens element 21, a ¼ wavelength film to a surface, of the reflective polarizing film, on the +Z side. The ¼ wave plate 42 and the polarizing reflective surface 41 are disposed such that orientations with respect to the polarization direction are aligned with each other.

The retardation element is not limited to a ¼ wave plate. The retardation element may be any element as long as the element gives, to incident light, a phase difference of ¼ wavelength in a predetermined polarization direction. For example, the retardation element may include two ⅛ wave plates or four 1/16 wave plates. The phase difference of ¼ wavelength given by the retardation element may be a phase difference of 0.24×λ to 0.26×λ in an electric field oscillation direction of polarized light.

The first lens group G1 constitutes a beam splitter lens including a half mirror 43. In the present embodiment, the half mirror 43 is provided on a cemented surface between the first and second lens elements 21 and 22. For example, the half mirror 43 is configured by applying visible light reflection coating, vapor deposition, or the like in which reflectance is set to a predetermined value, to the +Z-side surface of the first lens element 21 or to the −Z-side surface of the second lens element 22. The predetermined value of the reflectance is 50%, for example. The half mirror 43 between the first and second lens elements 21 and 22 is an example of a second partial reflection surface that reflects a part of incident light and transmits the rest.

For example, in the first lens group G1, a circular polarizer 44 is provided on a surface, of the second lens element 22, on the +Z side. The circular polarizer 44 is disposed so as to set the display light beam Bi from the display element 11 to clockwise circularly polarized light or counter-clockwise circularly polarized light. For example, the circular polarizer 44 is configured by bonding a circularly polarizing film to the +Z-side surface of the second lens element 22. The circular polarizer 44 is not limited to the above configuration and, for example, may be provided on a −Z-side surface or a +Z-side surface of the third lens element 23 of the second lens group G2, or may be provided between the visual optical system 12 and the display element 11 (e.g., the display surface of the display element 11).

For example, the first lens element 21 is a spherical lens and has a positive power. The −Z-side surface of the first lens element 21 is a flat surface, for example. As a result, it is easy to provide the polarizing reflective surface 41 and the ¼ wave plate 42. For example, the +Z-side surface of the first lens element 21 is a convex surface having a curvature radius corresponding to a focal length of the first lens element 21. The configuration of the first lens element 21 is not limited to the above, and the −Z-side surface may not be a flat surface, for example.

The second lens element 22 is a spherical lens and has a negative power, for example. For example, the −Z-side surface of the second lens element 22 is a concave surface having a curvature radius corresponding to the +Z-side surface of the cemented first lens element 21. The +Z-side surface of the second lens element 22 is a flat surface, for example. As a result, it is easy to provide the circular polarizer 44. The configuration of the second lens element 22 is not limited to the above, and the +Z-side surface may not be a flat surface, for example.

For example, the third lens element 23 of the second lens group G2 is positioned on the most +Z side in the visual optical system 12, and is disposed so as to face the display element 11. For example, the third lens element 23 is an aspherical lens having a rotationally symmetric aspherical surface on the +Z side and the −Z side and has a negative power. The third lens element 23 is configured of a lens material such as resin or glass.

The third lens element 23 has a smaller diameter than the first and second lens elements 21 and 22, for example. For example, when the third lens element 23 is made of a resin material, molding is easy, and the visual optical system 12 can therefore be easily manufactured. In addition, by using a resin lens material, it is easy to reduce a weight of the visual optical system 12, and it is easy to reduce cost, for example.

Third lens element 23 of the second lens group G2 has a power weaker than the power of the first lens group G1, for example. The −Z-side surface of the third lens element 23 is a convex surface that is convex toward the −Z side, for example. For example, the +Z-side surface of the third lens element 23 is a concave surface that is concave toward the +Z side. In the third lens element 23, the +Z-side surface has a shape more nearly flat than the shape of the −Z-side surface, for example. For example, in the third lens element 23, the curvature radius or a sag amount is smaller on the +Z-side surface than on the −Z-side surface.

### 2-2. Operation

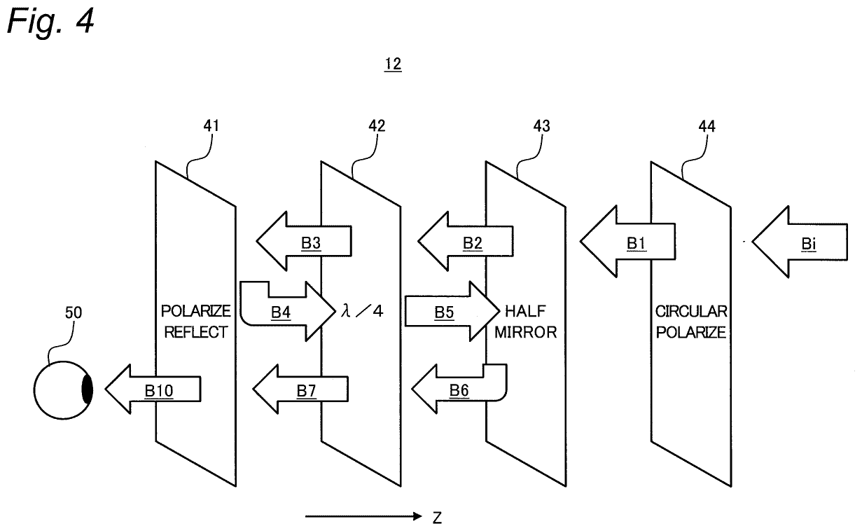

With reference to FIG. 4, an operation will be described in which the visual optical system 12 configured as described above functions as a polarizing reflection optical system in the HMD 1.

In the HMD 1, the display light beam Bi from the display element 11 first enters the visual optical system 12 from the +Z side as illustrated in FIG. 4, for example. For example, as illustrated in FIG. 3, the display light beam Bi incident on the visual optical system 12 is guided to the second lens group G2 and is incident on the first lens group G1. For example, based on the incident display light beam Bi, the circular polarizer 44 on the +Z side of the second lens element 22 in the first lens group G1 emits, to the −Z side, a display light beam B1 of the circular polarization previously set from the clockwise circular polarization or the counter-clockwise circular polarization.

In the first lens group G1 of the visual optical system 12, the half mirror 43 between the first and second lens elements 21 and 22 transmits, to the −Z side, a part of the incident display light beam B1 corresponding to a predetermined transmittance such as 50%, and emits a display light beam B2.

The display light beam B2 having been transmitted through the half mirror 43 is converted from circularly polarized light into p-polarized light when passing through the ¼ wave plate 42 in the first lens element 21, for example. For example, a p-polarized display light beam B3 is incident on the polarizing reflective surface 41 from the ¼ wave plate 42.

The polarizing reflective surface 41 reflects the above-described display light beam B3 incident from the ¼ wave plate 42 to the +Z side, based on a polarization state of the display light beam B3. A display light beam B4 reflected by the polarizing reflective surface 41 passes through the ¼ wave plate 42 again, and is converted from the p-polarized light into circularly polarized light. A display light beam B5 after the conversion travels to the +Z side and enters the half mirror 43 again.

Out of the display light beam B5 having entered again, the half mirror 43 reflects a display light beam B6 at a proportion corresponding to a predetermined reflectance such as 50%. The above-described display light beam B6 reflected by the half mirror 43 travels to the −Z side similarly to the display light beam B2 when the display light beam B2 having been transmitted through the half mirror 43, but travels as circularly polarized light polarized in the circular direction opposite to the circular polarization of the display light beam B2 that was transmitted through the half mirror 43, and the display light beam B6 enters the ¼ wave plate 42.

When passing through the ¼ wave plate 42, the above-described circularly polarized display light beam B6 polarized in the opposite circular direction is converted into an s-polarized display light beam B7 different from the p-polarized light that passed through last time, and is incident on the polarizing reflective surface 41. The polarizing reflective surface 41 transmits the converted display light beam B7, based on the polarization state of the display light beam B7. As a result, the display light beam B7 after transmission is emitted from the visual optical system 12 to the −Z side. A display light beam B10 thus emitted from the visual optical system 12 can reach the eye 50 of the user 5 (FIG. 1).

As described above, by using an optical path in which the display light beams B1 to B10 travel while being folded back between the polarizing reflective surface 41 and the half mirror 43 in the visual optical system 12, it is possible to adopt a lens element having a long optical path length and a small lens thickness, and it is easy to make the visual optical system 12 thin.

2-3. Various conditions

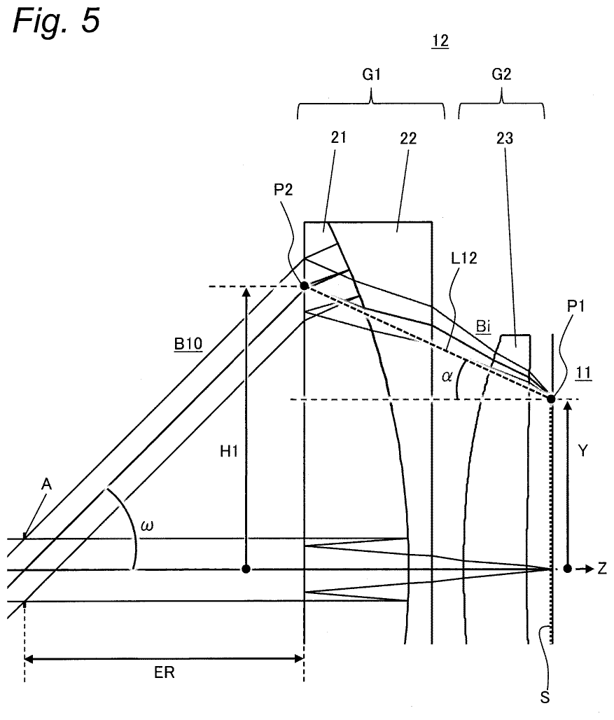

Various conditions satisfied by the visual optical system 12 of the present embodiment will be described with reference to FIGS. 5 to 7.

FIG. 5 is a diagram for illustrating parameters in the visual optical system 12. In the visual optical system 12 of the present embodiment, the first lens group G1 has a relatively strong power. Specifically, the visual optical system 12 of the present embodiment is configured such that a focal length f1 of the first lens group G1 is equal to or shorter than five times a difference (H1−Y) between a maximum height H1 of a chief ray assumed as a reference ray and a maximum image height Y of the display element 11 on the −Z-side surface of the first lens element 21 (hereinafter, this is also referred to as condition (1A)).

Based on condition (1A), by the relatively strong power of the first lens group G1, as exemplified in FIG. 5, it is possible to perform optical design so as to increase an inclination angle α defined between the first lens group G1 and the display element 11. The inclination angle α is an angle at which a straight line L12 is inclined with respect to the Z direction of the optical axis. The straight line L12 is a line between a position P1 of the maximum image height Y on the display element 11 and a position P2 at which a light ray emitted from the position P1 passes through the −Z-side surface of the first lens element 21.

In this way, by making the inclination angle a large in accordance with the power of the first lens group G1 on the basis of condition (1A), the visual optical system 12 of the present embodiment can be configured such that the visual optical system 12 is small and thin but achieves a wide viewing angle, thereby capable of ensuring a visual field for the user 5, for example.

The maximum height H1 of the chief ray is the maximum height of the chief ray passing through a center of pupil A among light ray heights when a plurality of light rays (see FIG. 3) emitted from various positions on the display surface S of the display element 11 individually pass through the −Z-side surface of the first lens element 21. The maximum image height Y is a maximum image height within a range where the display light beam Bi emitted from the display surface S of the display element 11 can reach the pupil A via the visual optical system 12. The pupil A corresponds to an exit pupil of the visual optical system 12, for example. The maximum image height Y is 8 mm or more and 20 mm or less, for example.

In the visual optical system 12 of the present embodiment, the light ray corresponding to the maximum height H1 of the chief ray is emitted from the position P1 of the maximum image height Y on the display element 11 as illustrated in FIG. 5, for example. The maximum height H1 of the chief ray is measured regarding the chief ray passing through the center of the pupil A, in a light flux emitted from an individual position on the display element 11, for example. For example, the maximum height H1 of the chief ray can be calculated as the following expression using a half angle of view ω of the visual optical system 12, the eye relief ER, and the tangent function tan( ).

$$H 1 = E R \times tan ( ω )$$

The eye relief ER is defined by a structure (e.g., the fixing member 14) of the HMD 1 and is a distance from the visual optical system 12 to a position at which the eye 50 of the user 5 wearing the HMD 1 (FIG. 1) in a zero diopter state is assumed to be positioned, for example.

The visual optical system 12 of the present embodiment may satisfy condition (1) defined as the following expression.

$$0.25 < ( H 1 - Y ) / f 1 \qquad ( 1 )$$

That is, the visual optical system 12 of the present embodiment may be configured such that the focal length f1 of the first lens group G1 is less than four times the difference between the maximum height H1 of the chief ray and the maximum image height Y. Condition (1A) corresponds to a state in which the lower limit value indicated on the left side of the above expression (1) is changed to “0.2”.

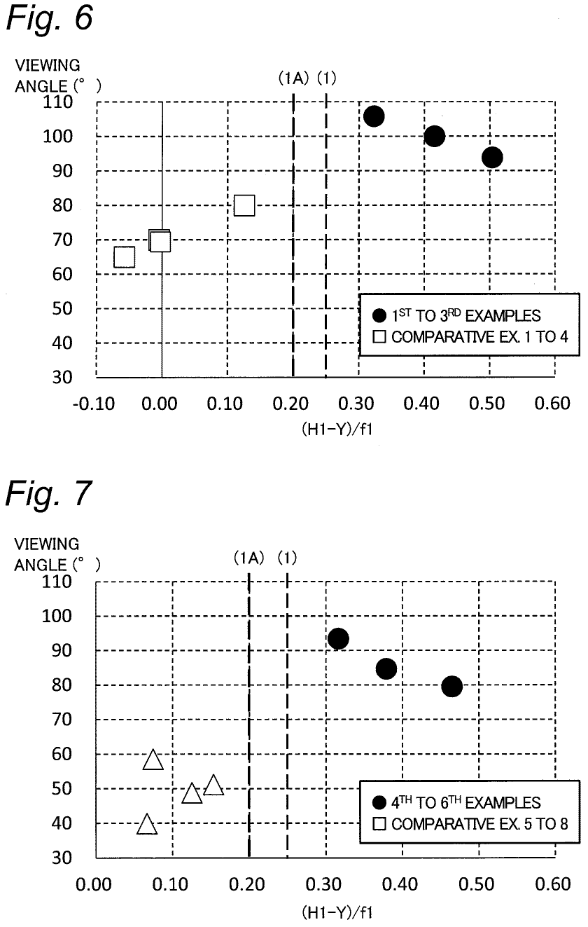

With reference to FIGS. 6 and 7, in order to confirm an effect of the visual optical system 12 of the present embodiment, a description will be given on results of comparison using examples of JP 2022-185302 A and JP 2021-81530 A as comparative examples.

FIGS. 6 and 7 are graphs illustrating first and second comparison results regarding the effect of the visual optical system 12. In FIGS. 6 and 7, the horizontal axis represents the calculated value of the right side “(H1−Y)/f1” of expression (1), and the vertical axis represents the viewing angle (°).

The graph in FIG. 6 illustrates the comparison results of first to third examples having relatively large image heights (e.g., 11 mm to 13 mm) and comparative examples 1 to 4. In FIG. 6, the plot with solid black circles indicates calculation results of the first to third examples (to be described later) of the visual optical system 12 of the present embodiment. The plot with open squares indicates calculation results of the first to fourth examples of JP 2022-185302 A as comparative examples 1 to 4.

As shown in FIG. 6, in comparative examples 1 to 4, the calculated values on the horizontal axis are less than the lower limit value of condition (1A), and comparative examples 1 to 4 do not satisfy condition (1A). This shows that, in comparative examples 1 to 4, although the image heights are relatively large, the obtained viewing angles are only at 80° or less.

In contrast, in the first to third examples of the visual optical system 12 of the present embodiment, as exemplified in FIG. 6, the calculated values on the horizontal axis are equal to or more than the lower limit value of condition (1A), and satisfy condition (1A). As a result, in the first to third examples of the visual optical system 12 of the present embodiment, the viewing angle exceeds 90°, and has a wider viewing angle than the comparative examples of JP 2022-185302 A having relatively large image heights. The first to third examples of the present embodiment also satisfy condition (1).

The graph in FIG. 7 illustrates comparison results of fourth to sixth examples (to be described later) having relatively small image heights (e.g., 5 mm to 9 mm) and comparative examples 5 to 8. In FIG. 7, the plot with solid black circles indicates calculation results of the fourth to sixth examples (to be described later) of the visual optical system 12 of the present embodiment. The plot with open triangles indicates calculation results of the first to fourth examples of JP 2021-81530 A as comparative examples 5 to 8.

As shown in FIG. 7, comparative examples 5 to 8 do not satisfy condition (1A), and only the viewing angles of less than 60° are obtained in comparative examples 5 to 8. In contrast, the fourth to sixth examples of the visual optical system 12 of the present embodiment satisfy condition (1A), and the viewing angles exceed 80°. As described above, with the visual optical system 12 of the present embodiment, it is possible to obtain a wider viewing angle as compared with comparative examples 5 to 8 having relatively small image heights. The fourth to sixth examples of the present embodiment satisfy condition (1) as well.

As described above, the following effect has been confirmed. The visual optical system 12 of the present embodiment facilitates obtaining a wide viewing angle when being configured to satisfy condition (1A). In addition, when condition (1) is satisfied, the visual optical system 12 of the present embodiment can more remarkably obtain an effect of obtaining a wide viewing angle even when configured to be small. Such an effect can also be remarkably obtained, in the visual optical system 12 of the present embodiment, by a configuration in which the power of the first lens group G1 of the first and second lens groups G1 and G2 is made relatively strong (see Expression (4)).

The visual optical system 12 of the present embodiment may satisfy condition (2) represented by the following expression.

$$( H 1 - Y ) / f 1 < 0.55 \qquad ( 2 )$$

When the left side of condition (2) is lower than the upper limit value of the above condition (2), the visual optical system 12 can be easily downsized. For example, in the visual optical system 12 of the present embodiment, when condition (2) is satisfied, the power of the first lens group G1 is not excessively increased, and it is therefore possible to avoid the lens from becoming large in size.

The visual optical system 12 of the present embodiment may satisfy the following conditional expression (3).

$$0 < \vert f / f 2 \vert < 0.1 \qquad ( 3 )$$

In the above expression (3), f is the focal length of the whole visual optical system 12, and f2 is the focal length of the second lens group G2. The above conditional expression (3) indicates, at for example the upper limit value, a reference for making the power of the second lens group G2 relatively weak with the power of the whole visual optical system 12 as a reference. The lower limit value of the above expression (3) indicates a reference for giving power to the second lens group G2.

When condition (3) is satisfied, in the visual optical system 12 of the present embodiment, it is possible to easily avoid a situation in which a change in temperature of the second lens group G2 due to heat from the display element 11 affects a performance of the visual optical system 12; therefore, it is easily to adopt a resin material as a lens material for the second lens group G2, for example. Specifically, a resin lens has a tendency that a power of the lens easily changes due to an increase in temperature. To address this issue, in the visual optical system 12 of the present embodiment, when the power of the second lens group G2 is decreased so as to fall below the upper limit value of condition (3), it is possible to reduce influence to the performance due to a change in temperature even when the second lens group G2 is a resin lens.

The visual optical system 12 of the present embodiment may satisfy the following conditional expression (4).

$$0.98 < \vert f / f 1 \vert < 1.02 \qquad ( 4 )$$

The above expression (4) indicates, at for example the upper limit value, a reference for making the power of the first lens group G1 relatively strong with the power of the whole visual optical system 12 as a reference. The above expression (4) indicates, at for example the upper limit value, a reference for avoiding the power of the first lens group G1 from being excessively increased. The lower limit value of the above expression (4) indicates a reference for avoiding the power of the first lens group G1 from being excessively decreased.

When condition (4) is satisfied, the visual optical system 12 of the present embodiment can easily achieve a wide viewing angle in the small visual optical system 12 or the like by appropriately increasing the power of the first lens group G1 so that conditional expression (4) falls below the upper limit value, for example. The power of the second lens group G2 can be relatively decreased, and it is possible to achieve a wide viewing angle and to easily reduce the influence to the performance due to a change in temperature. When conditional expression (4) exceeds the lower limit value of condition (4), it is easy to avoid a situation in which the visual optical system 12 becomes large in size or the viewing angle becomes narrow.

In the visual optical system 12 of the present embodiment, the +Z-side surface of the third lens element 23, in the second lens group G2, on the most +Z side may satisfy the following expression (5).

$$0 < \vert SagH \vert < 0.5 \qquad ( 5 )$$

In the above expression (5), SagH represents a sag amount on the +Z-side surface of the third lens element 23. For example, the sag amount SagH is measured with an effective radius on the +Z-side surface of the third lens element 23 as a reference height. For example, the above expression (5) indicates, at for example the upper limit value, a reference indicating that the +Z-side surface of the third lens element 23 has a nearly flat shape. The lower limit value of the above expression (5) indicates a reference for making the third lens element 23 different from a completely flat surface.

When condition (5) is satisfied, the +Z-side surface of the third lens element 23 is made in a nearly flat shape so that conditional expression (5) falls below the upper limit value, for example. Therefore, it is possible to uniform the influence of a change in temperature from the vicinity of the center of the lens surface to the periphery, so that reducing the influence to the performance of the visual optical system 12 due to heat generation of the display element 11 can be facilitated.

### 2-3-1. First Example

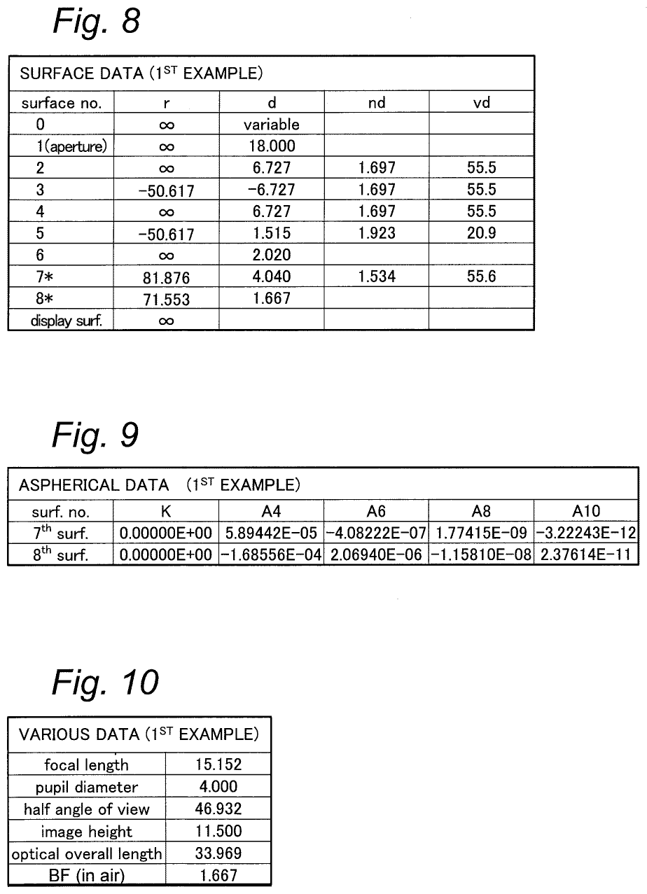

With reference to FIGS. 8 to 11A, 11B, and 11C, a description will be given on a numerical example of the visual optical system 12 of the first example that satisfies the conditional expressions (1A) and (1) to (5).

FIG. 8 shows surface data of the visual optical system 12 in a first numerical example. The surface data in FIG. 8 represents information of various surfaces through which the display light beams Bi and B1 to B10 pass in the visual optical system 12, in the order from an emission destination on further −Z side of the pupil A to the display surface S of the emission source. For example, the second and third surfaces are respectively the −Z-side surface and the +Z-side surface of the first lens element 21, and the fourth surface represents the same surface as the second surface, based on the reflection of the display light beams. The fifth and sixth surfaces are respectively the −Z-side surface and the +Z-side surface of the second lens element 22, and the seventh and eighth surfaces are respectively the −Z-side surface and the +Z-side surface of the third lens element 23.

In the surface data in FIG. 8, the information of each surface includes e.g. a curvature radius r and a surface interval d at the vertex (e.g., mm unit), and a refractive index nd and an Abbe number vd with respect to d-line of each element. The surface interval d has a sign corresponding to the +Z side or the −Z side. In FIG. 8, surface numbers of aspherical surfaces are suffixed by “*”.

FIG. 9 shows aspherical data of the visual optical system 12 in the first numerical example. The aspherical data in FIG. 9 represents various coefficients of the following expression (10) for defining a shape of a rotationally symmetric aspherical surface for each aspherical surface in FIG. 8.

$$\begin{matrix}[ Mathematical 1 ] & \\ z = \frac{{h}^{2} / r}{1 + \sqrt{1 - ( 1 + κ ) {( h / r )}^{2}}} + \sum {A}_{n} {h}^{n} & ( 10 )\end{matrix}$$

In the above expression (10), h is a height from the optical axis, z is a sag amount at the height h, K is a conic constant, r is a curvature radius of the vertex, and An is an nth-order aspherical coefficient. In the second term on the right side of the above expression (10), n is an even number of 4 or more and 10 or less, and a sum is calculated for all the n, for example. According to the above expression (10), the sag amount z corresponding to a distance between the tangential plane of the vertex and the point on the target surface at the height h is defined so as to have a deviation from a spherical shape in accordance with the aspherical coefficient Aₙ.

FIG. 10 shows various data of the visual optical system 12 in the first numerical example. The various data in FIG. 10 indicate the focal length f, the pupil diameter, the half angle of view, the image height, the optical overall length, and the back focus BF of the visual optical system 12 of the present numerical example. The pupil diameter is a diameter of the pupil A. The half angle of view corresponds to ½ of the viewing angle (see ω in FIG. 5). The back focus BF is a length in air, for example. The unit of the various lengths is “mm”, and the unit of the half angle of view is “°”.

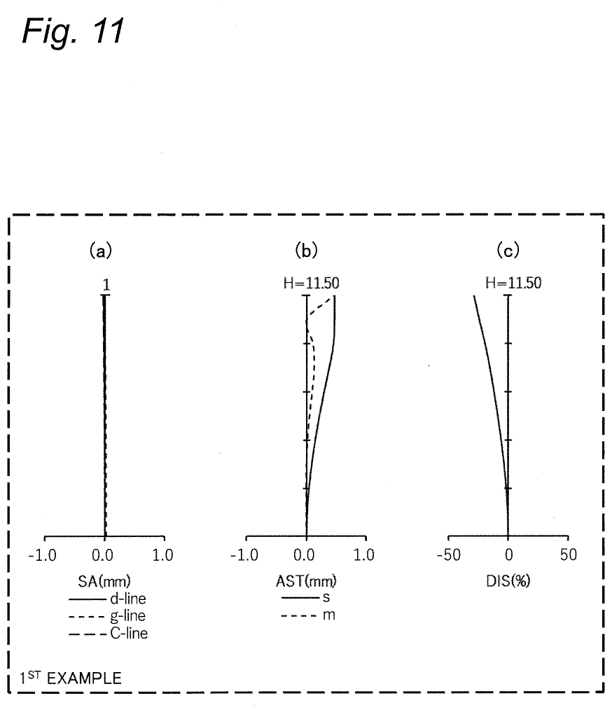

FIG. 11 is an aberration diagrams showing various aberrations of the visual optical system 12 in the present numerical example. Each of the following aberration diagrams exemplifies various longitudinal aberrations in a zero diopter state. FIGS. 11(a), 11(b) and 11(c) respectively show a spherical aberration diagram, an astigmatism diagram, and a distortion aberration diagram of the visual optical system 12 in to the present numerical example.

In FIG. 11(a) the horizontal axis represents the spherical aberration “SA” in the unit of mm, and the vertical axis represents the normalized pupil height. In the spherical aberration diagram, the solid line corresponding to “d-line” represents the characteristic with respect to d-line, the broken line corresponding to “g-line” represents the characteristic with respect to the g-line, and the broken line corresponding to “C-line” represents the characteristic with respect to the C-line. In FIG. 11(b) the horizontal axis represents the astigmatism “AST” in the unit of mm, and the vertical axis represents the image height. In the astigmatism diagram, the solid line corresponding to “s” represents the characteristic on the sagittal plane, and the broken line corresponding to “m” represents the characteristic on the meridional plane. In FIG. 11(c), the horizontal axis represents the distortion aberration “DIS” in the unit of %, and the vertical axis represents the image height.

The visual optical system 12 according to the present embodiment is not limited to the first example described above, and can be implemented in various forms. Hereinafter, the second to fourth examples of the visual optical system 12 will be described.

### 2-3-2. Second Example

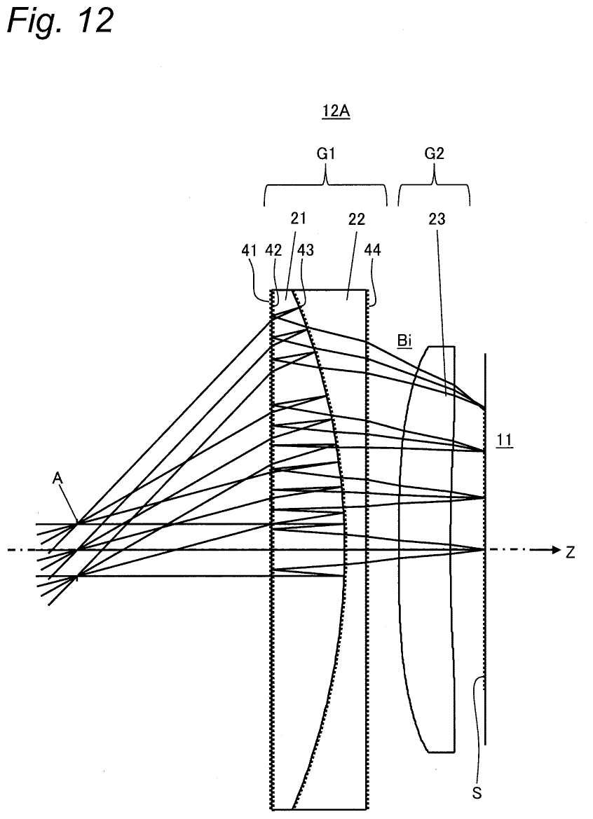

In a second example, with reference to FIGS. 12 to 16A, 16B, and 16C, a description will be given on an example in which the eye relief ER is shorter than the visual optical system 12 of the first example.

FIG. 12 shows, similarly to FIG. 3 of the first example, a configuration of a visual optical system 12A according to the second example. In the visual optical system 12A of the present example, various parameters such as lens shapes are changed in accordance with a reduction in the eye relief ER in a configuration similar to the configuration of the visual optical system 12 of the first example. For example, a lens diameter and the like in the visual optical system 12A can be reduced, and the visual optical system 12A can be easily downsized.

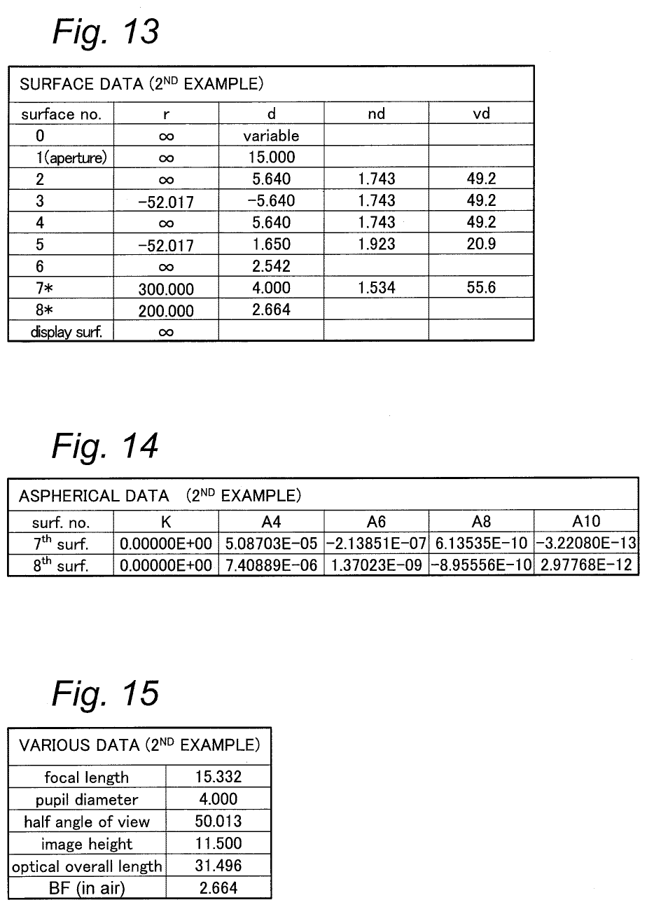

A numerical example corresponding to the visual optical system 12A of the second example is shown in FIGS. 13 to 15. FIG. 13 shows, similarly to FIG. 8, surface data of the visual optical system 12A in a second numerical example. FIG. 14 shows, similarly to FIG. 9, the aspherical data in the present example. FIG. 15 shows, similarly to FIG. 10, various data in the present example.

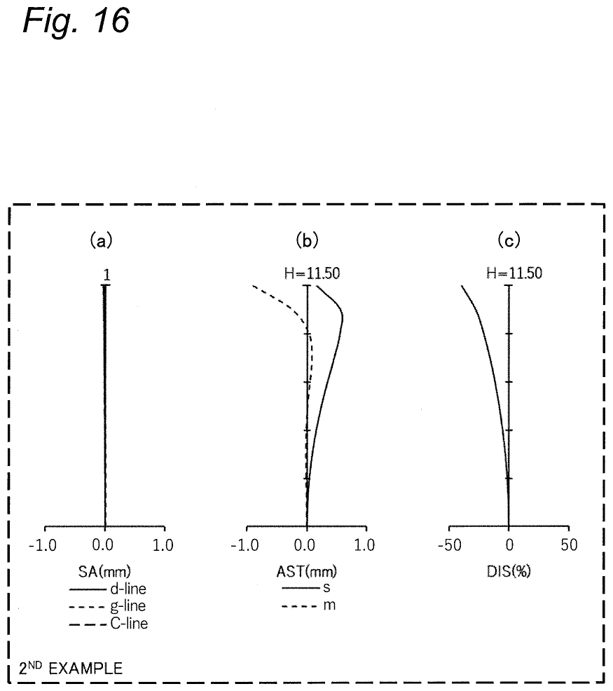

FIG. 16 shows various aberrations of the visual optical system 12A in the second numerical example. FIGS. 16(a), 16(b), and 16(c) respectively show, similarly to FIGS. 11(a), 11(b) and 11(c), aberration diagrams of the visual optical system 12A according to the present example. In addition, the visual optical system 12A of the present example satisfies conditions (1A) and (1) to (5). The same effects as in the first example can be obtained also by the visual optical system 12A of the present example. For example, for the user 5 of the HMD 1, it is possible to downsize the projection unit 10 and to easily obtain a visual field in which the virtual image Vis favorably viewed in a wide viewing angle.

### 2-3-3. Third Example

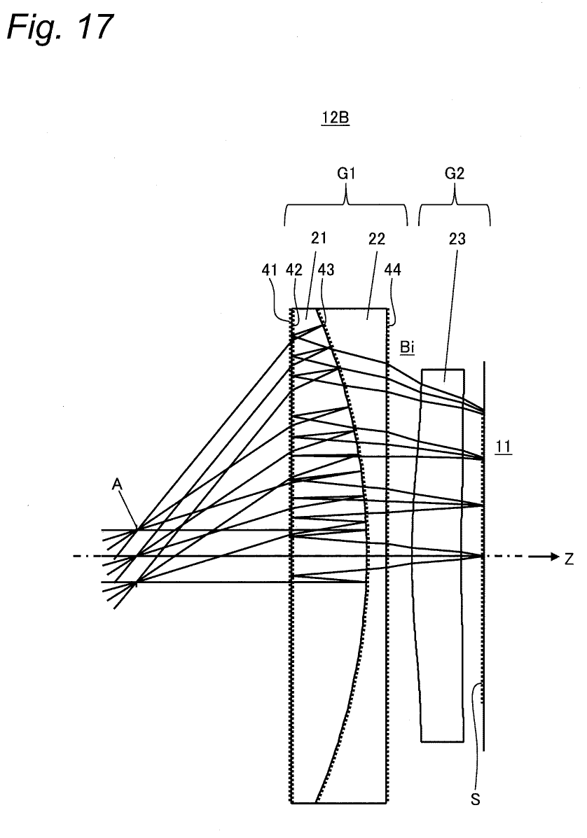

In the third example, with reference to FIGS. 17 to 21A, 21B, and 21C, a description will be given on an example in which the eye relief ER is even shorter than the visual optical system 12A of the second example.

FIG. 17 shows, similarly to FIG. 3 of the first example, a configuration of a visual optical system 12B according to the third example. In the visual optical system 12B of the present example, various parameters such as shapes of various aspherical surfaces are changed in accordance with a reduction in the eye relief ER in a configuration similar to the configuration of the visual optical system 12 of the first example.

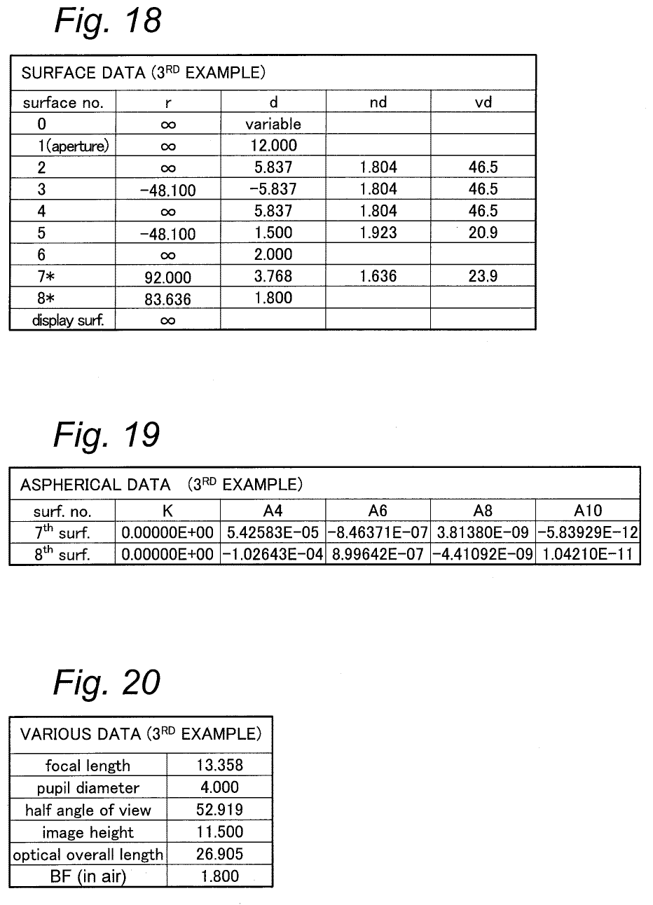

A numerical example corresponding to the visual optical system 12B of the third example is shown in FIGS. 18 to 20. FIG. 18 shows, similarly to FIG. 8, surface data of the visual optical system 12B in the third numerical example. FIG. 19 shows, similarly to FIG. 9, aspherical data in the present example. FIG. 20 shows, similarly to FIG. 10, various data in the present example.

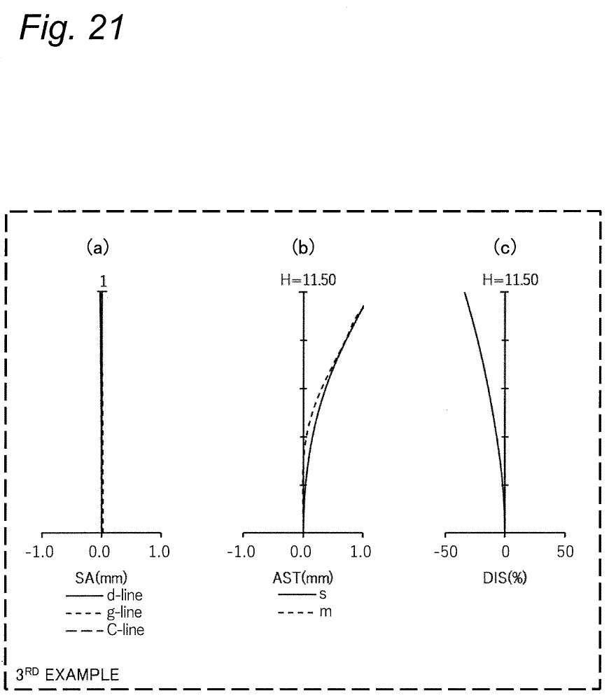

FIG. 21 shows various aberrations of the visual optical system 12B in the third numerical example. FIGS. 21(a), 21(b), and 21(c) respectively show, similarly to FIGS. 11(a), 11(b) and 11(c), aberration diagrams of the visual optical system 12B according to the present example. In addition, the visual optical system 12B of the present example satisfies conditions (1A) and (1) to (5), and such a configuration also makes it possible to obtain the same effects as in the first example.

### 2-3-4. Fourth Example

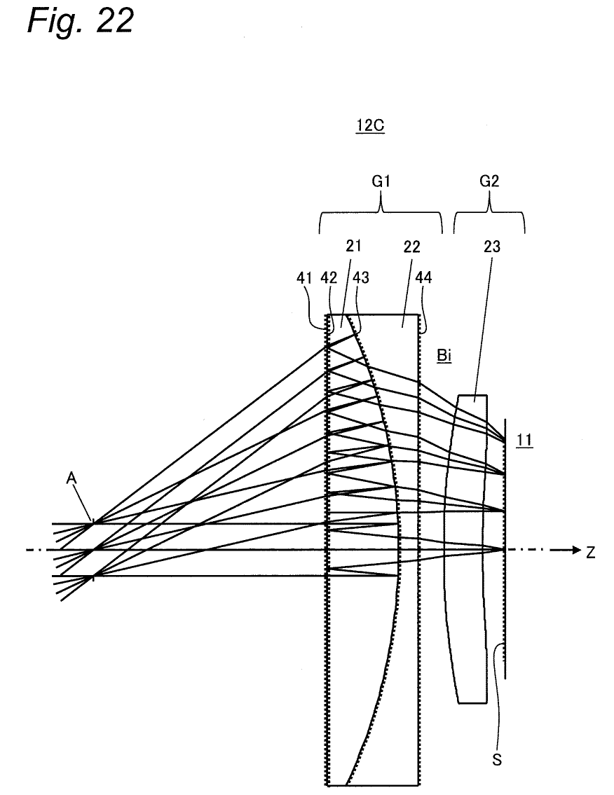

In a fourth example, with reference to FIGS. 22 to 26A, 26B, and 26C, a description will be given on an example in which the image height is smaller than that of the visual optical system 12 of the first example.

FIG. 22 shows, similarly to FIG. 3 of the first example, a configuration of a visual optical system 12C according to the fourth example. In the visual optical system 12C of the present example, various parameters are changed in accordance with the reduction in the image height on the display surface S in a configuration similar to the configuration of the visual optical system 12 of the first example.

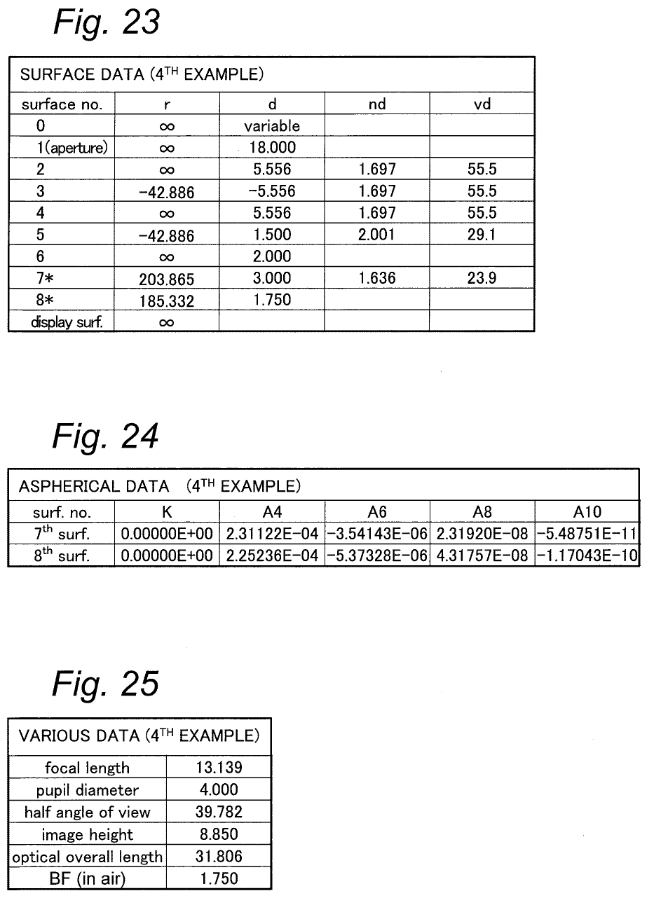

A numerical example corresponding to the visual optical system 12C of the fourth example is shown in FIGS. 23 to 25. FIG. 23 shows, similarly to FIG. 8, surface data of the visual optical system 12C in the fourth numerical example. FIG. 24 shows, similarly to FIG. 9, aspherical data in the present example. FIG. 25 shows, similarly to FIG. 10, various data in the present example.

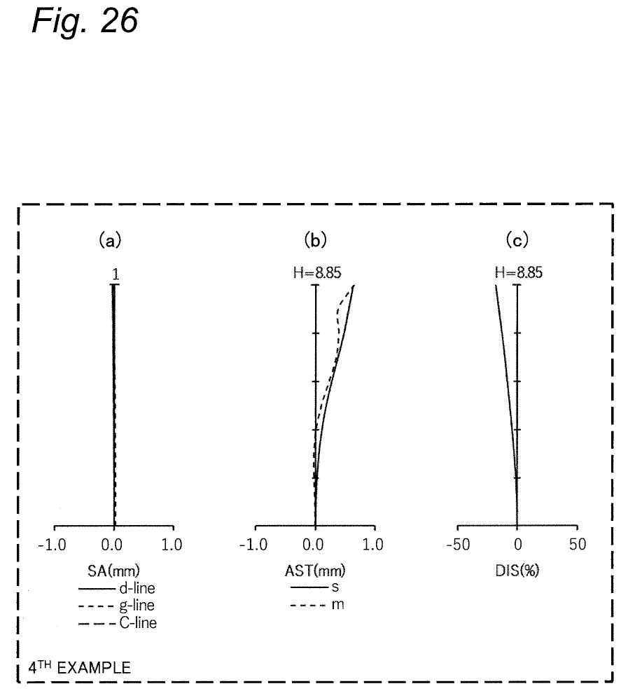

FIG. 26 shows various aberrations of the visual optical system 12C in the fourth numerical example. FIGS. 26(a), 26(b), and 26(c) respectively show, similarly to FIGS. 11(a), 11(b) and 11(c), aberration diagrams of the visual optical system 12C according to the present example. In addition, the visual optical system 12C of the present example satisfies conditions (1A) and (1) to (5), and such a configuration also makes it possible to obtain the same effects as in the first example.

### 2-3-5. Fifth Example

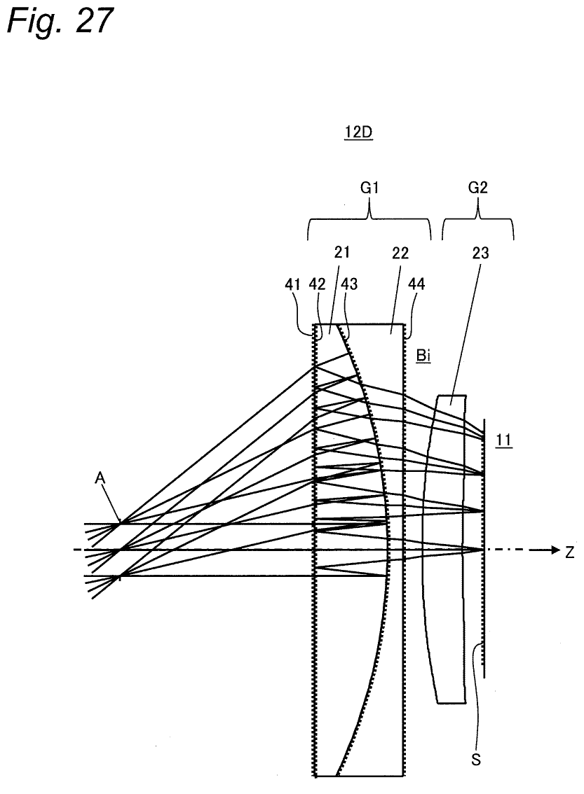

In a fifth example, with reference to FIGS. 27 to 31A, 31B, and 31C, a description will be given on an example in which the eye relief ER is shorter than the visual optical system 12C of the fourth example.

FIG. 27 shows, similarly to FIG. 3 of the first example, a configuration of a visual optical system 12D according to the fifth example. In the visual optical system 12D of the present example, various parameters are changed in accordance with a reduction in the eye relief ER similar to the reduction in the second example in a configuration similar to the configuration of the visual optical system 12C of the fourth example.

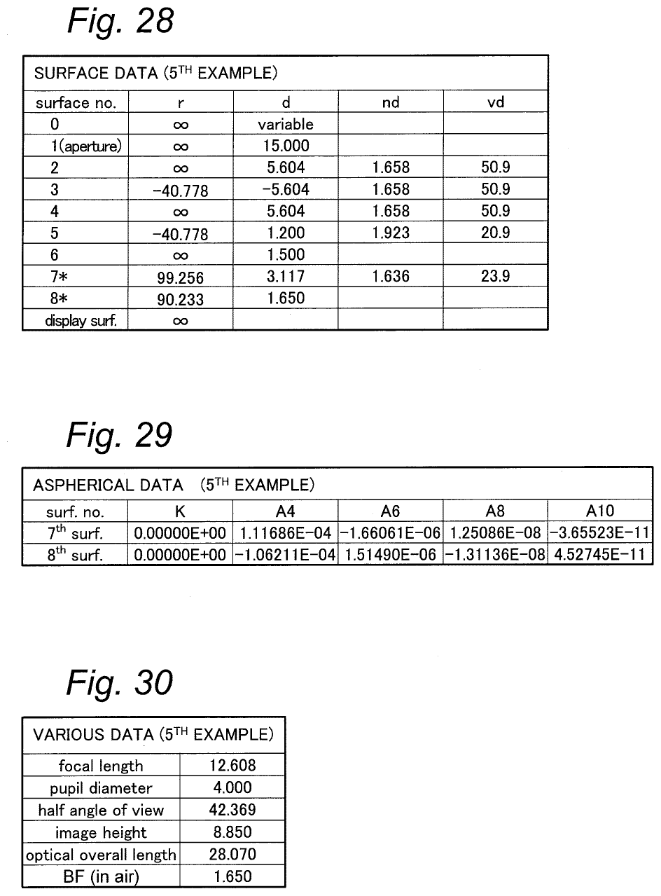

A numerical example corresponding to the visual optical system 12D of the fifth example is shown in FIGS. 28 to 30. FIG. 28 shows, similarly to FIG. 8, surface data of the visual optical system 12D in the fifth numerical example. FIG. 29 shows, similarly to FIG. 9, aspherical data in the present example. FIG. 30 shows, similarly to FIG. 10, various data in the present example.

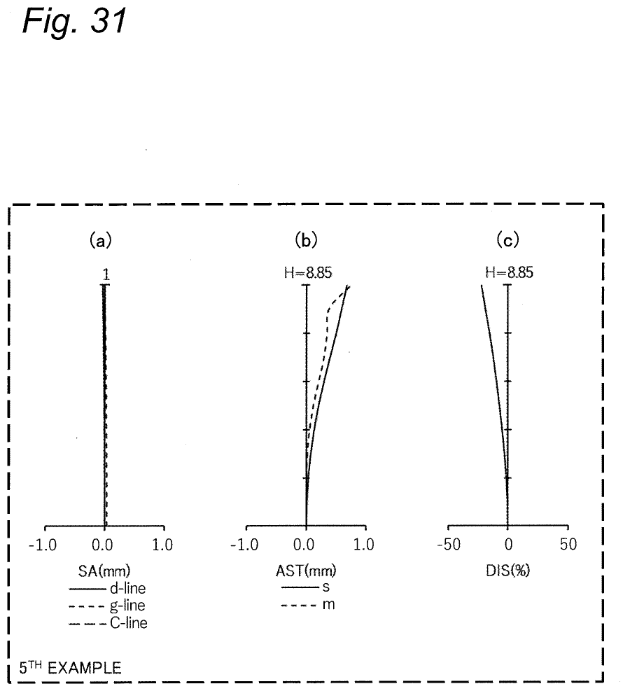

FIG. 31 shows various aberrations of the visual optical system 12D in the fifth numerical example. FIGS. 31(a), 31(a), and 31(c) respectively show, similarly to FIGS. 11(a), 11(b) and 11(c), aberration diagrams of the visual optical system 12D according to the present example. In addition, the visual optical system 12D of the present example satisfies conditions (1A) and (1) to (5), and such a configuration also makes it possible to obtain the same effects as in the first example.

### 2-3-6. Sixth Example

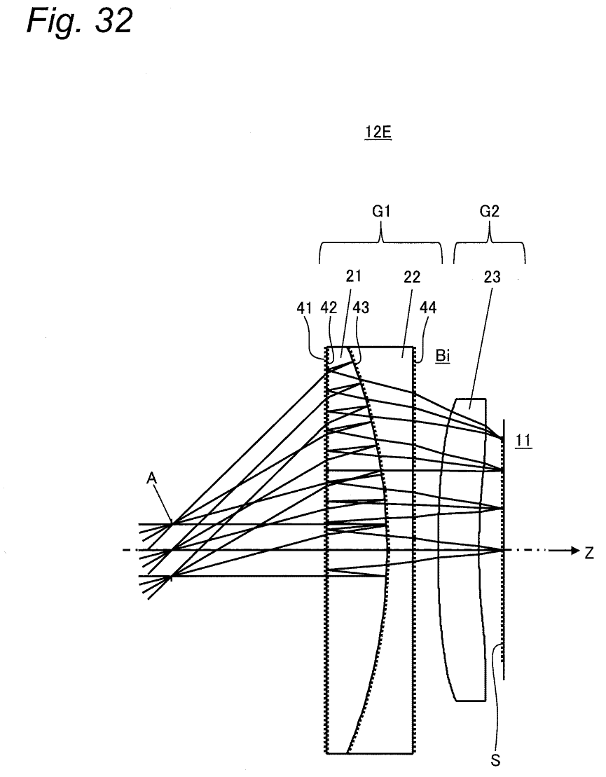

In a sixth example, with reference to FIGS. 32 to 36A, 36B, and 36C, a description will be given on an example in which the eye relief ER is even shorter than that of the visual optical system 12D of the fifth example.

FIG. 32 shows, similarly to FIG. 3 of the first example, a configuration of a visual optical system 12E according to the sixth example. In the visual optical system 12E of the present example, various parameters are changed in accordance with a reduction in the eye relief ER similar to the reduction in the third example in a configuration similar to the configuration of the visual optical system 12C of the fourth example.

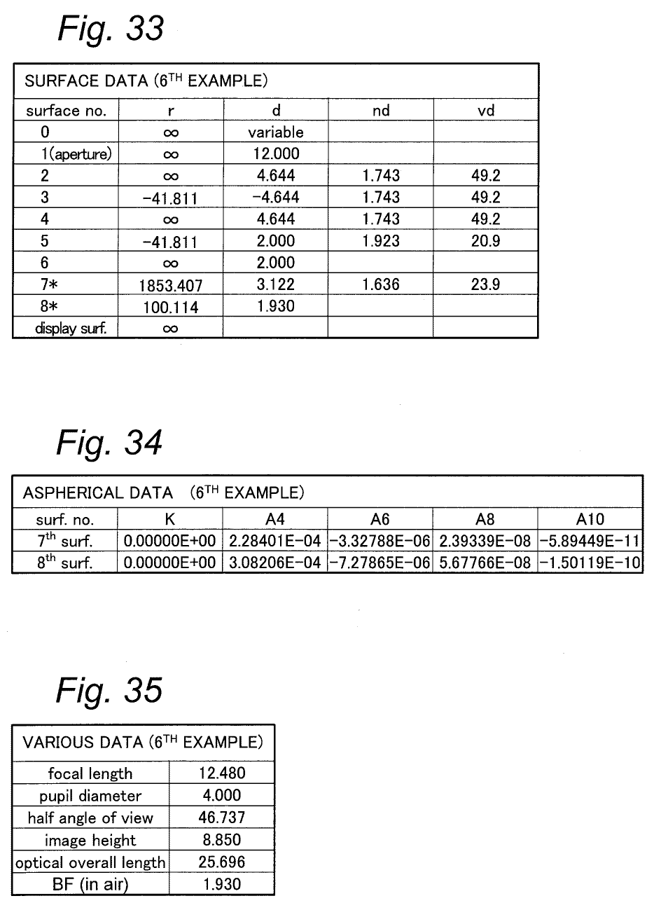

A numerical example corresponding to the visual optical system 12E of the sixth example is shown in FIGS. 33 to 35. FIG. 33 shows, similarly to FIG. 8, surface data of the visual optical system 12E in the sixth numerical example. FIG. 34 shows, similarly to FIG. 9, aspherical data in the present example. FIG. 35 shows, similarly to FIG. 10, various data in the present example.

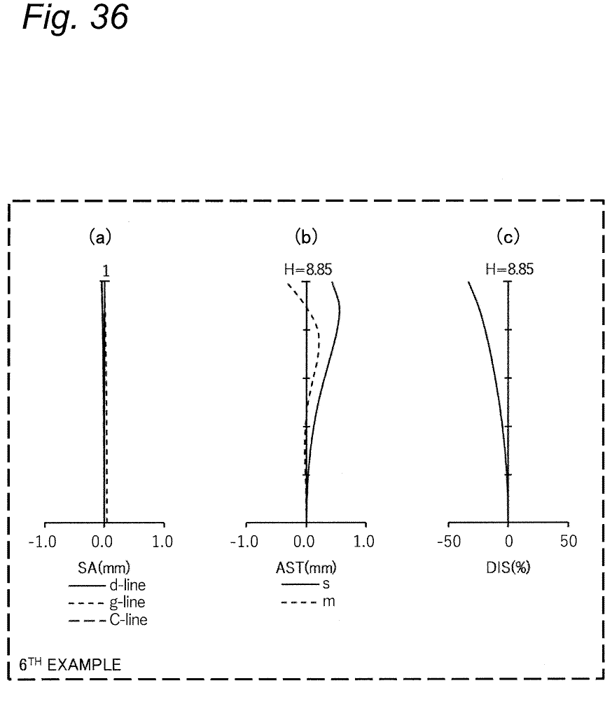

FIG. 36 shows various aberrations of the visual optical system 12E in the sixth numerical example. FIGS. 36(a), 36(a), and 36(c) respectively show, similarly to FIGS. 11(a), 11(b) and 11(c), aberration diagrams of the visual optical system 12E according to the present example. In addition, the visual optical system 12E of the present example satisfies conditions (1A) and (1) to (5), and such a configuration also makes it possible to obtain the same effects as in the first example.

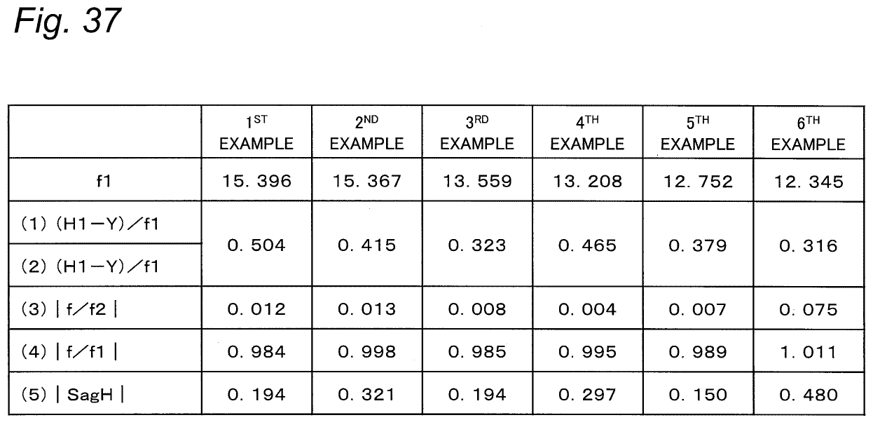

FIG. 37 shows satisfiability of various conditions in the visual optical system 12 according to the present embodiment. FIG. 37 shows, for each example of the visual optical system 12, the focal length f1 of the first lens group G1 and the calculated values of conditional expressions (1) to (5). As illustrated in FIG. 37, the visual optical systems 12 and 12A to 12E of the first to sixth examples each satisfy each of the above-described conditions (1) to (5). In addition, the visual optical systems 12 and 12A to 12E of the first to sixth examples also satisfy condition (1A).

### 3. Review

As described above, the visual optical system 12 in the present embodiment is an example of an eyepiece optical system that guides light between the pupil A of the user 5 and the display surface S. The visual optical system 12 includes the first lens group G1 and the second lens group G2 arranged in order from the side of the pupil of the user 5 (−Z side) to the display side (+Z side), the display side (+Z side) being on the way toward the display surface S. The first lens group G1 includes the first lens element 21 and the second lens element 22 arranged in order from the pupil side to the display side, and includes the polarizing reflective surface 41 on the pupil side of the first lens element 21 and the half mirror 43 between the first lens element 21 and the second lens element 22. The second lens group G2 includes the third lens element 23 having an aspherical surface convex toward the pupil side. The focal length f1 of the first lens group G1 is equal to or less than five times the difference between the maximum height H1 of a chief ray on the pupil side surface, on the pupil side, of the first lens element 21 in the first lens group G1 and the maximum image height Y on the display surface S (condition (1A)).

With the visual optical system 12 of the present embodiment, as the above condition (1A) is satisfied, a wide viewing angle can be easily obtained, facilitating ensuring a visual field of the user 5 of the HMD 1, for example.

The visual optical system 12 of the present embodiment may satisfy the above- described condition (1). For example, obtaining a wide viewing angle can be facilitated with using a small display element 11 and the visual optical system 12 configured in a small size.

$$0.25 < ( H 1 - Y ) / f 1 \qquad ( 1 )$$

The visual optical system 12 of the present embodiment may satisfy the above-described condition (2). As a result, the visual optical system 12 can be easily downsized.

$$( H 1 - Y ) / f 1 < 0.55 \qquad ( 2 )$$

The visual optical system 12 of the present embodiment may satisfy the above-described condition (3). For example, from the viewpoint of suppressing an influence, to performance of the visual optical system 12, due to a change in temperature of the second lens group G2 caused by heat from the display element 11, a low-cost resin material or the like can be easily used for the second lens group G2. Furthermore, the visual optical system 12 can be easily downsized.

$$0 < \vert f / f 2 \vert < 0.1 \qquad ( 3 )$$

The visual optical system 12 of the present embodiment may satisfy the above-described condition (4). As a result, it is possible to relatively increase the power of the first lens group G1 to easily obtain a wide viewing angle and to suppress the influence, to the performance, due to a change in temperature. Furthermore, the visual optical system 12 can be easily downsized.

$$0.98 < \vert f / f 1 \vert < 1.02 \qquad ( 4 )$$

In the visual optical system 12 of the present embodiment, the third lens element 23 may be disposed on the display side in the second lens group G2, and the above-described condition (5) may be satisfied. As a result, even when a resin lens is used as the third lens element 23 whose temperature is likely to change due to heat generation from the display element 11, it is possible to suppress a variation in power of the third lens element 23 and to thereby suppress an influence to the performance of the visual optical system 12. Thus, cost of the visual optical system 12 can be reduced.

$$0 < \vert SagH \vert < 0.5 \qquad ( 5 )$$

The eyepiece optical system of the present embodiment may further include the diopter adjustment mechanism 13 as an example of a movable mechanism that moves the first lens group G1 along the optical axis of the visual optical system 12. The diopter adjustment mechanism 13 of the present embodiment is configured to move the first lens group G1 to adjust a diopter of the user 5. Such a diopter adjustment mechanism 13 makes it easy for the user 5 to use the HMD 1.

In the present embodiment, the maximum image height Y on the display surface S may be 20 mm or less. As a result, the visual optical system 12 can be easily downsized. In the present embodiment, the maximum image height Y on the display surface S may be 8 mm or more. As a result, it can facilitate obtaining a wide viewing angle in the visual optical system 12.

The visual optical system 12 of the present embodiment may further include the ¼ wave plate 42 as an example of a retardation element, on the pupil side of the first lens element 21. In addition, the visual optical system 12 of the present embodiment may further include a polarizing element such as the circular polarizer 44, on the display side of the second lens element 22.

In the present embodiment, the HMD 1 is an example of a display device including: the display element 11 having the display surface S for displaying an image; and the eyepiece optical system 12. With to the HMD 1 of the present embodiment, it is possible to facilitate ensuring the visual field of the user 5 by the visual optical system 12. The HMD 1 of the present embodiment may further include the fixing member 14 that is fixed to a head portion of the user 5 to position the eyepiece optical system 12.

In the HMD 1 of the present embodiment, the display element 11 may be a micro OLED. As a result, it is easy to make the image quality of the virtual image V in the HMD 1 high definition.

### OTHER EMBODIMENTS

The first embodiment has been described in the above as an example of the techniques disclosed in the present application. However, the techniques of the present disclosure can be applied not only to the above embodiments but also to an embodiment in which modification, replacement, addition, or removal is appropriately made. Furthermore, it is possible to form a new embodiment by combining the components described in the above embodiment. Therefore, other embodiments will be exemplified below.

The above first embodiment has described the visual optical system 12 including: the two lens elements 21 and 22 as the first lens group G1; and one lens element 23 as the second lens group G2; however, the present disclosure is not limited thereto. In the present embodiment, the visual optical system 12 may include, as the first lens group G1, three or more lens elements, or may include, as the second lens group G2, two or more lens elements. By increasing the number of lenses as described above, the optical design for obtaining a wide viewing angle can be facilitated, and the visual field of the user can be easily ensured also by the visual optical system of the present embodiment similarly to the first embodiment. For example, the visual optical system 12 of the present embodiment may include one or more lens elements between the second lens element 22 and the third lens element 23. In addition, optical elements having no power such as flat plates may be provided at various places in the visual optical system 12 of the present embodiment.

In the above embodiments, the diopter adjustment mechanism 13 has been described as an example of the movable mechanism in the eyepiece optical system. In the present embodiment, the movable mechanism of the eyepiece optical system may move the lens group of the first and second lens elements 21 and 22 in the Z direction for a purpose different from the diopter adjustment, and may be used for zooming or focusing, for example.

In the above embodiments, an example has been described in which the HMD 1 includes the diopter adjustment mechanism 13 movable in the Z direction. In the present embodiment, the HMD 1 may include a diopter adjustment means different from the diopter adjustment mechanism 13 movable in the Z direction, and for example, may be configured such that a correction lens for diopter adjustment can be separately attached.

In the above embodiments, an example has been described in which the polarizing reflective surface of the visual optical system 12 reflects p-polarized light and transmits s-polarized light, but the polarizing reflective surface is not limited thereto. In the visual optical system 12 of the present embodiment, the polarizing reflective surface may reflect s-polarized light and transmit p-polarized light, or may selectively reflect or transmit circularly polarized light. In the above embodiments, an example has been described in which the polarizing reflective surface 41 and the ¼ wave plate 42 are used in the visual optical system 12, but the ¼ wave plate 42 may be omitted.

In the above embodiments, an example has been described in which a rotationally symmetric aspherical surface is used in each of the lens elements 21 and 22 of the visual optical system 12. In the present embodiment, a rotationally asymmetric aspherical surface may be used for each of the lens elements 21 and 22, and for example, a free-form surface such as an anamorphic aspherical surface or an XY polynomial surface may be used.

In the above embodiments, the spectacle-type HMD 1 is exemplified as an example of a display device to which the visual optical system 12 is applied, but the present disclosure is not limited thereto. In the present embodiment, the HMD 1 is not limited to the spectacle type, and may be a goggle-type HMD or an HMD for single eye vision. In the present embodiment, the display device to which the visual optical system 12 is applied is not limited to the HMD, and may be various viewfinders such as an electronic viewfinder, for example. Also in such various display devices, it is possible to facilitate ensuring the visual field of the user by the visual optical system 12.

In the above embodiments, a configuration example has been described in which the first lens element 21 and the second lens element 22 are cemented in the visual optical system 12. In the visual optical system 12 of the present embodiment, the first lens element 21 and the second lens element 22 may not be particularly cemented. In this case, a shape of the +Z-side surface of the first lens element 21 and a shape of the −Z-side surface of the second lens element 22 may not be particularly the same. In the visual optical system 12 in this case, when the first lens group G1 having a gap between the first lens element 21 and the second lens element 22 is configured as appropriate, it is possible to facilitate ensuring the visual field of the user similarly to the visual optical system 12 of each of the above embodiments.

In the above embodiments, a configuration example has been described in which, in the visual optical system 12, the first partial reflection surface is the polarizing reflective surface 41 and the second partial reflection surface is the half mirror 43. In the visual optical system 12 of the present embodiment, the first partial reflection surface does not necessarily need to be the polarizing reflective surface 41, and the second partial reflection surface does not necessarily need to be the half mirror 43. For example, the first partial reflection surface of the present embodiment may be a half mirror. In addition, the second partial reflection surface of the present embodiment may be a polarizing reflective surface. Also in such a case, similarly to the visual optical system 12 of each of the above embodiments, the visual optical system 12 of the present embodiment can facilitate ensuring the visual field of the user by using the optical path that travels while being folded back between the first partial reflection surface and the second partial reflection surface.

### ASPECT EXAMPLES

Hereinafter, various aspects according to the present disclosure will be exemplified.

A first aspect of the present disclosure is an eyepiece optical system that guides light between a pupil of a user and a display surface. The eyepiece optical system includes a first lens group and a second lens group that are arranged in order from a user's pupil side to a display side, the display side being on the way toward the display surface. The first lens group includes a first lens element and a second lens element that are arranged in order from the pupil side to the display side, and has a first partial reflection surface on the pupil side of the first lens element and a second partial reflection surface between the first lens element and the second lens element. The second lens group includes a third lens element having an aspherical surface convex toward the pupil side. A focal length of the first lens group is equal to or less than five times a difference between a maximum height of a chief ray on a pupil side surface, on the pupil side, of the first lens element in the first lens group and a maximum image height on the display surface.

In a second aspect, in the eyepiece optical system according to the first aspect, the following condition (1) is satisfied.

$$0. 25 < ( H 1 - Y ) / f 1 \qquad ( 1 )$$

where H1 is a maximum height of a chief ray on a pupil side surface of the first lens group, Y is the maximum image height on the display surface, and f1 is the focal length of the first lens group.

In a third aspect, in the eyepiece optical system according to the first or second aspect, the following condition (2) is satisfied.

$$( H 1 - Y ) / f 1 < 0.55 \qquad ( 2 )$$

In a fourth aspect, in the eyepiece optical system according to any one of the first to third aspects, the following condition (3) is satisfied.

$$0 < \vert f / f 2 \vert < 0.1 \qquad ( 3 )$$

Here, f is a focal length of the eyepiece optical system, and f2 is a focal length of the second lens group.

In a fifth aspect, in the eyepiece optical system according to any one of the first to fourth aspects, the following condition (4) is satisfied.

$$0.98 < \vert f / f 1 \vert < 1.02 \qquad ( 4 )$$

Here, f1 is the focal length of the first lens group.

In a sixth aspect, in the eyepiece optical system according to any one of the first to fifth aspects, the third lens element is disposed on the display side in the second lens group, and the following condition (5) is satisfied.

$$0 < \vert SagH \vert < 0.5 \qquad ( 5 )$$

where SagH is a sag amount of a display side surface of the third lens element.

In a seventh aspect, the eyepiece optical system according to any one of the first to sixth aspects further includes a movable mechanism that moves the first lens group along an optical axis of the eyepiece optical system.

In an eighth aspect, in the eyepiece optical system according to the seventh aspect, the movable mechanism is configured to move the first lens group to adjust a diopter of the user.

In a ninth aspect, in the eyepiece optical system according to any one of the first to eighth aspects, the maximum image height on the display surface is 20 mm or less.

In a tenth aspect, in the eyepiece optical system according to any one of the first to ninth aspects, the maximum image height on the display surface is 8 mm or more.

In an eleventh aspect, in the eyepiece optical system according to any one of the first to tenth aspects, the first lens element and the second lens element are cemented.

In a twelfth aspect, in the eyepiece optical system according to any one of the first to eleventh aspects, the first partial reflection surface is a polarizing reflective surface that reflects or transmits incident light based on polarization of the incident light, and the second partial reflection surface is a half mirror that reflects a part of incident light and transmits a remaining part of the incident light.

In a thirteenth aspect, in the eyepiece optical system according to any one of the first to tenth aspects, the eyepiece optical system further includes a retardation element that is provided on a surface, of the first lens element, on the pupil side and causes a phase delay of ¼ wavelength.

In a fourteenth aspect, the eyepiece optical system according to any one of the first to thirteenth aspects further includes a circular polarizer provided on a surface, of the second lens element, on the display side.

A fifteenth aspect is a head mounted display including: a display element having a display surface that displays an image; and the eyepiece optical system according to any one of the first to fourteenth aspects.

In a sixteenth aspect, in the head mounted display according to the fifteenth aspect, the display element is a micro organic light emitting diode display.

As described above, the embodiments have been described as examples of the techniques in the present disclosure. For that purpose, the accompanying drawings and the detailed description are provided.

Therefore, the components illustrated in the accompanying drawings and described in the detailed description not only include components essential for solving the problem but also can include, to exemplify the techniques, components that are not essential for solving the problem. For this reason, it should not be immediately recognized that those unnecessary components are necessary only because those unnecessary components are described in the accompanying drawings or the detailed description.

Since the embodiments described above are for exemplifying the techniques in the present disclosure, various modifications, replacements, additions, omissions, and the like can be made in the scope of the claims or in an equivalent scope thereof.

The eyepiece optical system of the present disclosure is applicable to various display devices such as an HMD and a viewfinder.

1. An eyepiece optical system for guiding light between a pupil of a user and a display surface, the eyepiece optical system comprising:
a first lens group and a second lens group that are arranged in order from a pupil side of the user to a display side that is toward the display surface, wherein
the first lens group includes a first lens element and a second lens element that are arranged in order from the pupil side to the display side, and has a first partial reflection surface and a second partial reflection surface, the first partial reflection surface being disposed on the pupil side of the first lens element, and the second partial reflection surface being disposed between the first lens element and the second lens element,
the second lens group includes a third lens element having an aspherical surface convex toward the pupil side, and
a focal length of the first lens group is equal to or less than five times a difference between a maximum height of a chief ray on a pupil side surface and a maximum image height on the display surface, the pupil side surface being a surface on the pupil side of the first lens element in the first lens group.

2. The eyepiece optical system according to claim 1, wherein a following condition (1) is satisfied:
$$0. 25 < ( H 1 - Y ) / f 1 \qquad ( 1 )$$
where
H1 is the maximum height of the chief ray on the pupil side surface of the first lens group,
Y is the maximum image height on the display surface, and
f1 is the focal length of the first lens group.

3. The eyepiece optical system according to claim 2, wherein a following condition (2) is satisfied:
$$( H 1 - Y ) / f 1 < 0.55 \qquad ( 2 )$$

4. The eyepiece optical system according to claim 1, wherein a following condition (3) is satisfied:
$$0 < \vert f / f 2 \vert < 0.1 \qquad ( 3 )$$
where
f is a focal length of the eyepiece optical system, and
f2 is a focal length of the second lens group.

5. The eyepiece optical system according to claim 1, wherein a following condition (4) is satisfied:
$$0.98 < \vert f / f 1 \vert < 1.02 \qquad ( 4 )$$
where
f1 is the focal length of the first lens group.

6. The eyepiece optical system according to claim 4, wherein the third lens element is disposed on the display side in the second lens group, and a following condition (5) is satisfied:
$$0 < \vert SagH \vert < 0.5 \qquad ( 5 )$$
where
SagH is a sag amount of a display side surface of the third lens element.

7. The eyepiece optical system according to claim 1, further comprising a movable mechanism configured to move the first lens group along an optical axis of the eyepiece optical system.

8. The eyepiece optical system according to claim 7, wherein the movable mechanism is configured to move the first lens group to adjust a diopter of the user.

9. The eyepiece optical system according to claim 1, wherein the maximum image height on the display surface is 20 mm or less.

10. The eyepiece optical system according to claim 9, wherein the maximum image height on the display surface is 8 mm or more.

11. The eyepiece optical system according to claim 1, wherein the first lens element and the second lens element are cemented with each other.

12. The eyepiece optical system according to claim 1, wherein
the first partial reflection surface is a polarizing reflective surface that reflects or transmits incident light based on polarization of the incident light, and
the second partial reflection surface is a half mirror that reflects a part of incident light and transmits a remaining part of the incident light.

13. The eyepiece optical system according to claim 1, further comprising a retardation element provided on the pupil side surface of the first lens element, to cause a phase delay of ¼ wavelength.

14. The eyepiece optical system according to claim 13, further comprising a circular polarizer provided on a surface on the display side of the second lens element.

15. A head mounted display comprising:
a display element having the display surface that displays an image; and
the eyepiece optical system according to claim 1.

16. The head mounted display according to claim 15, wherein the display element is a micro organic light emitting diode display.
